(19) United States
(12) Patent Application Publication
(10) Pub. No.: US 2026/0233522 A1
(43) Pub. Date: Aug. 13, 2026

(54) LIQUID EJECTING HEAD AND LIQUID EJECTING APPARATUS

(71) Applicant: SEIKO EPSON CORPORATION, Tokyo (JP)

(72) Inventor: Yuichi KATANIWA, SHIOJIRI-SHI (JP)

(21) Appl. No.: 19/537,941

(22) Filed: Feb. 12, 2026

(30) Foreign Application Priority Data
Feb. 13, 2025 (JP) 2025-021873

(51) Int. Cl. B41J 2/14; B41J 3/54

(52) U.S. Cl. CPC B41J 2/14233; B41J 2/1433; B41J 3/543; B41J 2002/14241; B41J 2002/14258; B41J 2002/14306; B41J 2002/14491

(57) ABSTRACT

A liquid ejecting head includes a head chip, a holder holding the head chip, and a relay member, in which the head chip includes a first flow path member, a pressure chamber substrate, a drive element, a flexible substrate electrically coupled to the drive element, a protective substrate, and a second flow path member having an opening portion into which the flexible substrate is inserted, the second flow path member being laminated on the first flow path member at a position different from a position of the pressure chamber substrate, and the relay member is a member that is inserted into the opening portion of the second flow path member and does not define a flow path through which liquid flows, the relay member including a contact portion that contacts an upper surface of the protective substrate, and a supported portion supported by the holder.

The present application is based on, and claims priority from JP Application Serial Number 2025-021873, filed February 13, 2025, the disclosure of which is hereby incorporated by reference herein in its entirety.

### BACKGROUND

### Technical Field

The present disclosure relates to a liquid ejecting head and a liquid ejecting apparatus that eject liquid from nozzles, and particularly to an ink jet recording head and an ink jet recording apparatus that discharge ink as liquid.

### Related Art

A liquid ejecting head includes a head chip that ejects liquid, a fixing plate to which a plurality of head chips are fixed, and a holder that holds the plurality of head chips with the fixing plate (for example, see JP-A-2023-83724). The head chip includes a nozzle plate having nozzles formed therein for ejecting liquid droplets, a communication plate for supplying liquid to the nozzles, a pressure chamber substrate provided with a pressure chamber communicating with the nozzles, a drive element provided on the pressure chamber substrate via a diaphragm, a protective substrate disposed above the pressure chamber substrate, and a case provided above the communication plate.

In a liquid ejecting head in the related art, a gap is provided between an upper surface of a protective substrate and a lower surface of a case so that the protective substrate and the case are not adhered to each other. However, when an external force is applied to the liquid ejecting head in a direction opposite to a liquid ejecting direction, due to contact of a medium with a nozzle plate or a fixing plate of the liquid ejecting head, for example due to a medium transport failure, there is a problem that a fixing plate deforms with a part fixed to a holder of the fixing plate as a fulcrum, or the nozzle plate is pushed upward, causing the protective substrate to be displaced with respect to the case to fill the gap, which leads to damage of the substrates constituting the liquid ejecting head.

### SUMMARY

According to an aspect of the present disclosure, there is provided a liquid ejecting head including a first head chip having a nozzle for ejecting liquid in a first direction, a holder disposed in a second direction opposite to the first direction and holding the first head chip, and a relay member, in which the first head chip includes a first flow path member having a flow path communicating with the nozzle, a pressure chamber substrate having a pressure chamber communicating with the nozzle and laminated on the first flow path member in the second direction, a drive element for generating a pressure change in liquid within the pressure chamber, a flexible substrate electrically coupled to the drive element, a protective substrate laminated on the pressure chamber substrate in the second direction and accommodating the drive element, and a second flow path member having a flow path communicating with the flow path of the first flow path member and an opening portion into which the flexible substrate is inserted, the second flow path member being laminated in the second direction with respect to the first flow path member at a position different from a position of the pressure chamber substrate, and the relay member is a member that is inserted into the opening portion of the second flow path member and does not define a flow path through which liquid flows, the relay member including a contact portion that contacts an upper surface of the protective substrate facing the second direction, and a supported portion supported by the holder.

Further, according to another aspect of the present disclosure, there is provided a liquid ejecting apparatus including the liquid ejecting head described in the above aspect, and a liquid storage portion for storing liquid to be supplied to the liquid ejecting head.

### BRIEF DESCRIPTION OF THE DRAWINGS

FIG. 1 is a diagram illustrating a schematic configuration of a liquid ejecting apparatus according to Embodiment 1.

FIG. 2 is an exploded perspective view of a liquid ejecting head according to Embodiment 1.

FIG. 3 is a cross-sectional view of the liquid ejecting head according to Embodiment 1.

FIG. 4 is a perspective view of a relay member according to Embodiment 1.

FIG. 5 is an enlarged cross-sectional view of a main part of the liquid ejecting head according to Embodiment 1.

FIG. 6 is an exploded perspective view of a head chip according to Embodiment 1.

FIG. 7 is a plan view of the head chip according to Embodiment 1.

FIG. 8 is a cross-sectional view of the head chip and a fixing plate according to Embodiment 1.

FIG. 9 is a perspective view of the relay member according to a modification example of Embodiment 1.

FIG. 10 is a cross-sectional view of a liquid ejecting head according to Embodiment 2.

FIG. 11 is a perspective view of a holder and a relay member according to Embodiment 2, with the main part of the holder and relay member cut out.

FIG. 12 is a perspective view of a relay member according to Embodiment 3.

FIG. 13 is a cross-sectional view of a liquid ejecting head according to Embodiment 3.

FIG. 14 is a cross-sectional view illustrating a manufacturing method of the liquid ejecting head according to Embodiment 3.

FIG. 15 is a perspective view of a relay member according to a modification example of Embodiment 3.

### DESCRIPTION OF EMBODIMENTS

The present disclosure will be described in detail below based on embodiments. However, the following description shows one aspect of the present disclosure, and can be modified as desired within the scope of the present disclosure. In each drawing, the same reference numerals indicate the same members, and the description thereof will be omitted as appropriate. In addition, in each drawing, X, Y, and Z represent three spatial axes that are orthogonal to each other. In the present specification, directions along these axes will be referred to as X directions, Y directions, and Z directions. In each drawing, a direction indicated by an arrow is a positive (+) direction, and a direction opposite to the arrow is a negative (-) direction. In addition, the directions of three spatial axes that do not limit the positive direction and the negative direction will be described as an X-axis direction, a Y-axis direction, and a Z-axis direction.

### Embodiment 1

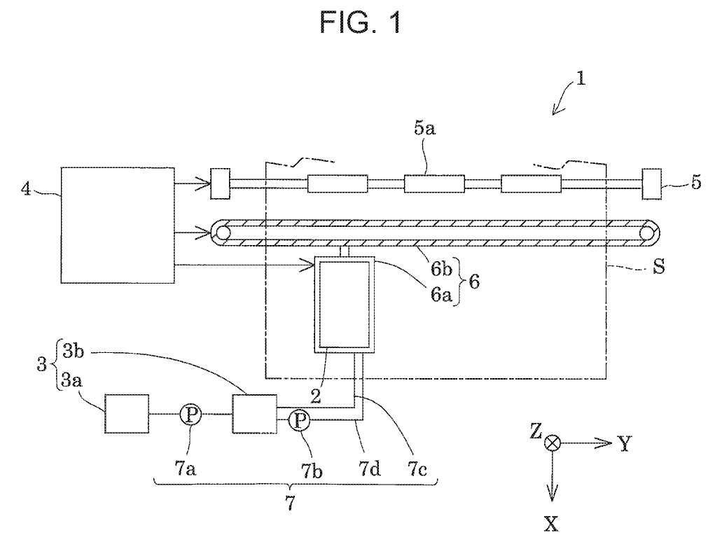

FIG. 1 is a view showing a schematic configuration of a liquid ejecting apparatus 1 according to the present disclosure.

As illustrated, the liquid ejecting apparatus 1 is an ink jet recording apparatus that causes ink, which is one type of liquid, to be ejected and land on a medium S such as a printing paper sheet as ink droplets, and prints an image or the like based on an arrangement of dots formed at the medium S. For the medium S, any material such as recording paper, resin film, or cloth can be used.

The liquid ejecting apparatus 1 includes a liquid ejecting head 2, a liquid storage portion 3, a control unit 4 which is a control portion, a transport mechanism 5 that sends out a medium S, and a movement mechanism 6.

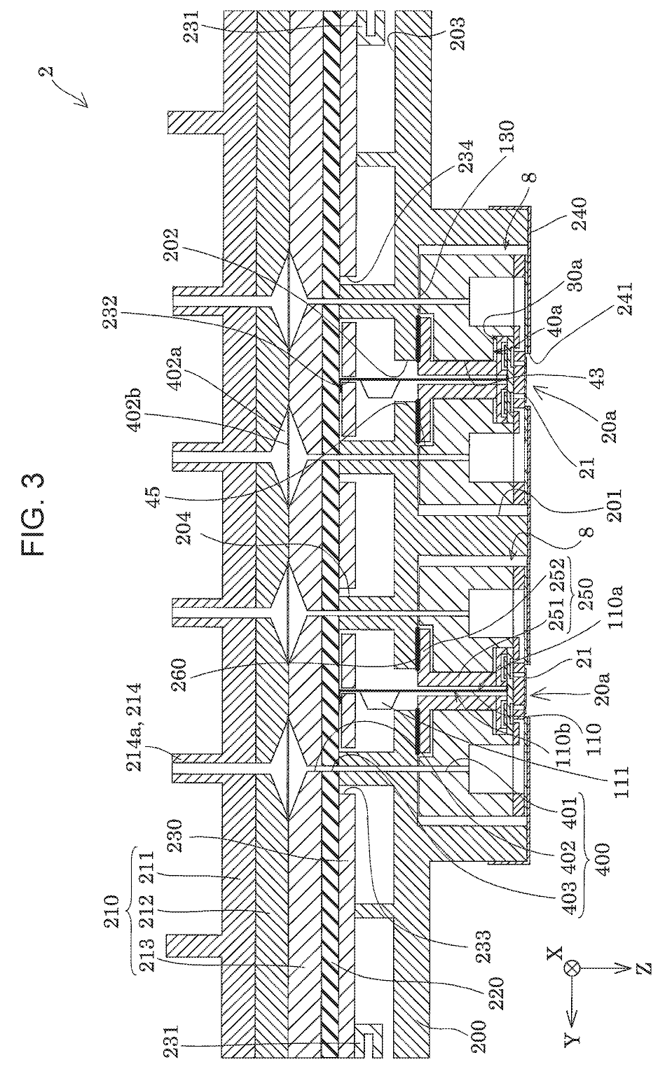

The liquid ejecting head 2 ejects the ink supplied from the liquid storage portion 3 from a plurality of nozzles 21 (refer to FIG. 3) to the medium S. The detailed configuration of the liquid ejecting head 2 will be described later.

The liquid storage portion 3 stores the ink to be ejected from the liquid ejecting head 2. Examples of the liquid storage portion 3 include a cartridge detachable from the liquid ejecting apparatus 1, a bag-shaped ink pack formed of a flexible film, and an ink tank that can be replenished with ink. Although not particularly illustrated in the drawings, for example, a plurality of types of ink with different colors and components are individually stored in the liquid storage portion 3.

In the present embodiment, the liquid storage portion 3 has a main tank 3a and a sub tank 3b for each type of ink. The sub tank 3b is coupled to the liquid ejecting head 2, and the sub tank 3b is replenished with the ink consumed by ejecting the ink droplets from the liquid ejecting head 2 from the main tank 3a. It is needless to say that the liquid storage portion 3 may be configured by only the main tank 3a.

The liquid ejecting apparatus 1 includes a circulation mechanism 7 for circulating the ink between the liquid ejecting head 2 and the sub tank 3b.

The circulation mechanism 7 includes a supply pump 7a, a circulation pump 7b, the sub tank 3b, a recovery tube 7c, and a supply tube 7d.

The supply pump 7a is a pump that supplies the ink stored in the main tank 3a to the sub tank 3b. The circulation pump 7b is a pump for supplying, that is, pressure-feeding the ink stored in the sub tank 3b to the liquid ejecting head 2.

The recovery tube 7c is a member that is not used for printing in the liquid ejecting head 2 and forms a flow path of ink recovered in the sub tank 3b. The supply tube 7d is a member that forms a flow path of the ink that is supplied from the sub tank 3b to the liquid ejecting head 2.

The sub tank 3b is a container that temporarily stores the ink supplied from the liquid storage portion 3. In addition, the sub tank 3b is not used for printing in the liquid ejecting head 2, and temporarily stores the ink recovered through the recovery tube 7c.

In the circulation mechanism 7, ink is supplied from the sub tank 3b to the liquid ejecting head 2 through the supply tube 7d by the circulation pump 7b, and ink that is not used in the liquid ejecting head 2 is recovered into the sub tank 3b through the recovery tube 7c. As a result, the ink circulates between the liquid ejecting head 2 and the sub tank 3b. Further, when the amount of ink stored in the sub tank 3b is equal to or less than a certain amount, the ink is supplied from the main tank 3a to the sub tank 3b by the supply pump 7a.

The control unit 4 includes, for example, a control device such as a central processing unit (CPU) or a field programmable gate array (FPGA), and a storage device such as a semiconductor memory. The control unit 4 comprehensively controls each element of the liquid ejecting apparatus 1, that is, the liquid ejecting head 2, the transport mechanism 5, the movement mechanism 6, and the like by executing the program stored in the storage device by the control device.

The transport mechanism 5 transports the medium S in the X-axis direction and has a transport roller 5a. That is, the transport mechanism 5 transports the medium S in the X-axis direction by rotating the transport roller 5a. The transport mechanism 5 that transports the medium S is not limited to the one including the transport roller 5aand may transport the medium S by a belt or a drum, for example.

The movement mechanism 6 includes a transport body 6a and a transport belt 6b. The transport body 6a is a substantially box-shaped structure for accommodating the liquid ejecting head 2, a so-called carriage, and is fixed to the transport belt 6b. The transport belt 6b is an endless belt installed along the Y-axis direction. The transport belt 6b is rotated by the drive of a transport motor (not illustrated). The control unit 4 rotates the transport belt 6b by controlling the drive of the transport motor to reciprocate the liquid ejecting head 2 together with the transport body 6a in the Y-axis direction along a guide rail (not illustrated). The sub tank 3b of the liquid storage portion 3 can also be mounted on the transport body 6a together with the liquid ejecting head 2.

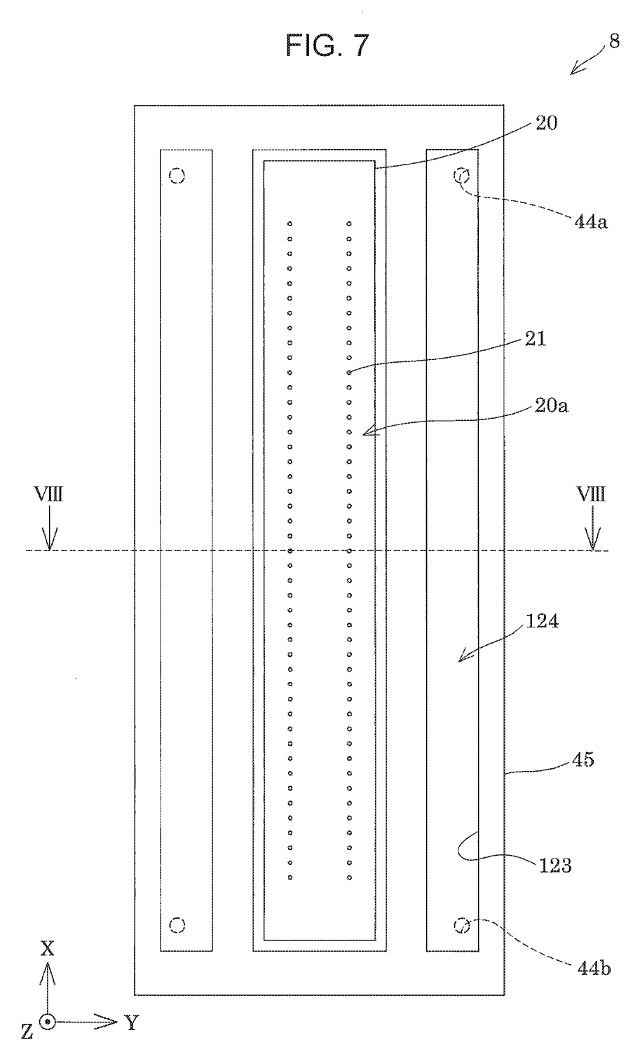

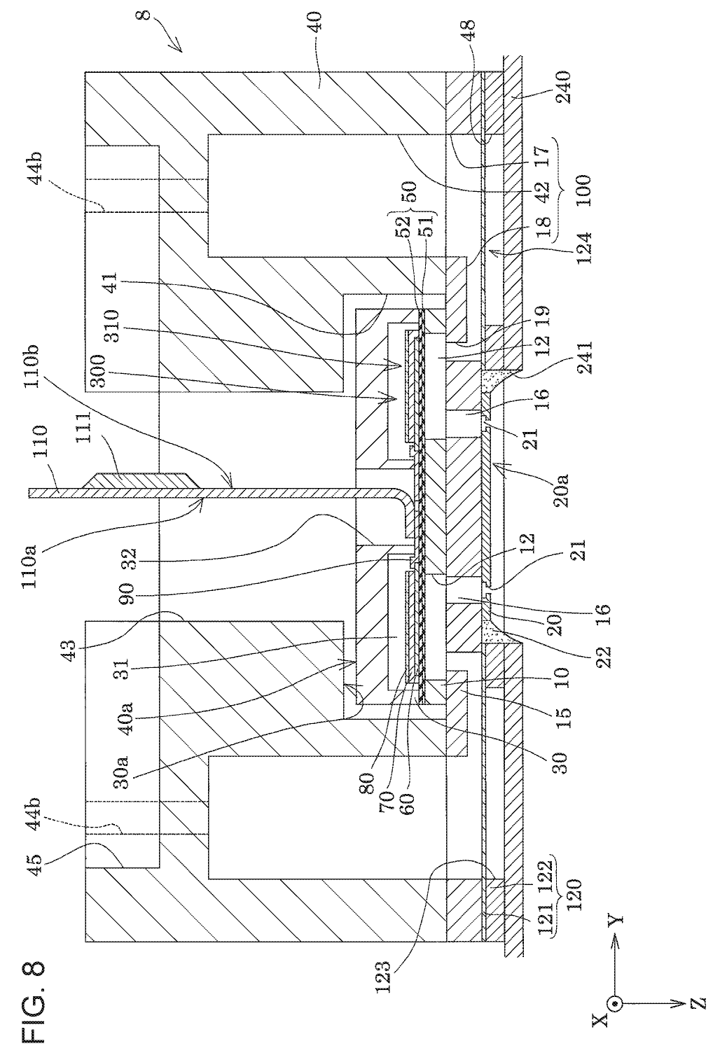

Under the control of the control unit 4, the liquid ejecting head 2 executes an ejecting operation of ejecting the ink supplied from the liquid storage portion 3 in the +Z direction as ink droplets from each of a plurality of nozzles 21 (refer to FIGS. 7 and 8). The ejecting operation of ink droplets by the liquid ejecting head 2 is performed in parallel with the transport of the medium S by the transport mechanism 5 and the reciprocating movement of the liquid ejecting head 2 by the movement mechanism 6, and accordingly, an image is formed by ink on the surface of the medium S, that is, a so-called printing operation is performed.

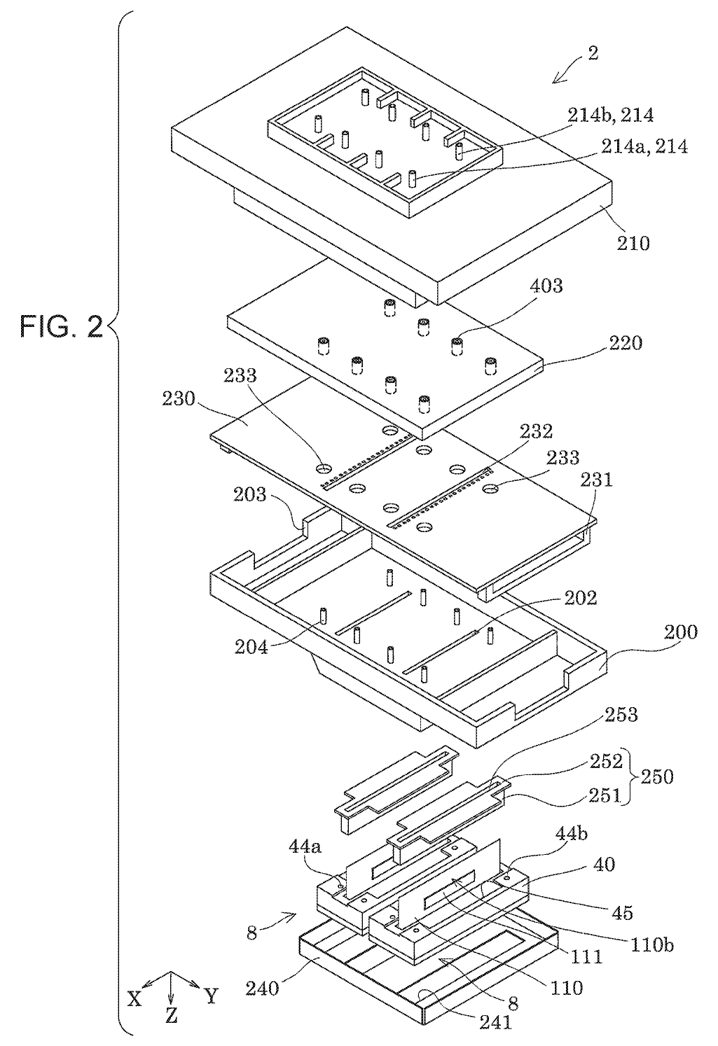

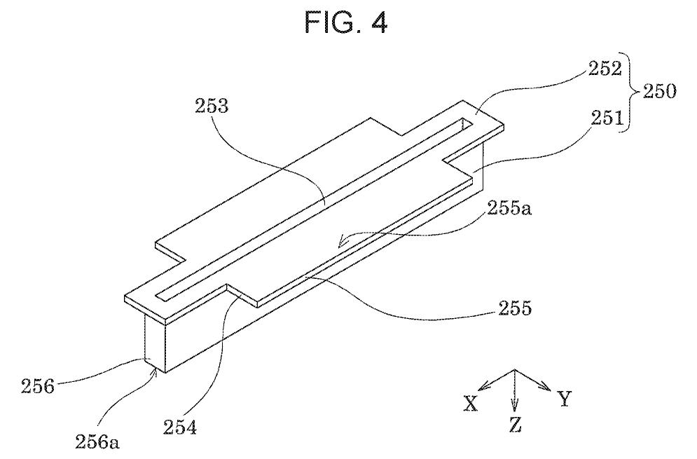

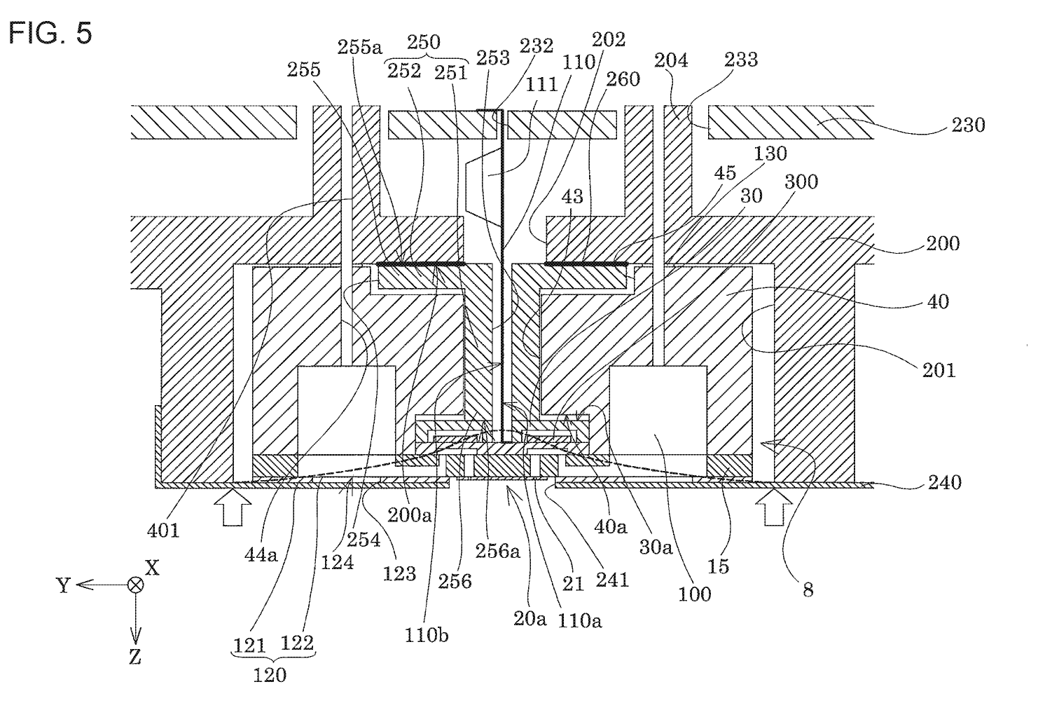

FIG. 2 is an exploded perspective view of the liquid ejecting head 2. FIG. 3 is a cross-sectional view of the liquid ejecting head 2 and is a cross-sectional view taken along the Y-axis direction and the Z-axis direction. FIG. 4 is a perspective view of a relay member 250. FIG. 5 is an enlarged view of the main part of FIG. 3. Each direction of the liquid ejecting head 2 will be described based on the directions when mounted on the liquid ejecting apparatus 1, that is, the X-axis direction, the Y-axis direction, and the Z-axis direction. Of course, the position of the liquid ejecting head 2 in the liquid ejecting apparatus 1 is not limited to those illustrated below.

As illustrated, the liquid ejecting head 2 includes a head chip 8, a holder 200, a coupling flow path member 210, a seal member 220, a relay substrate 230, a fixing plate 240, and a relay member 250.

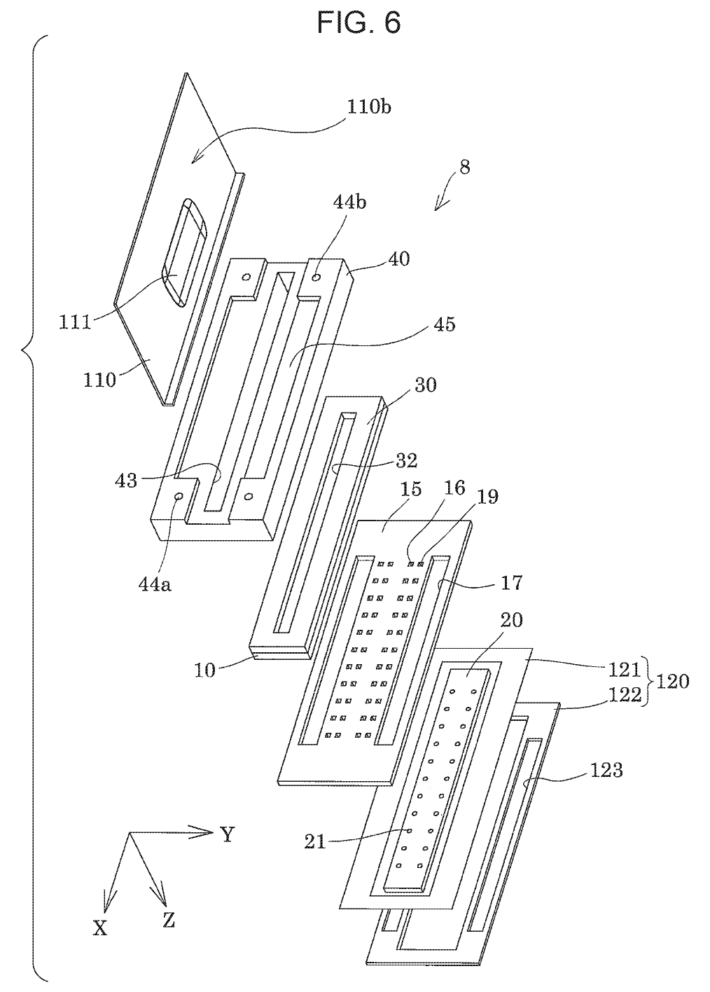

The head chip 8 of the present embodiment will be described. FIG. 6 is an exploded perspective view of the head chip 8. FIG. 7 is a plan view of a pressure chamber substrate 10 of the head chip 8 when viewed in the +Z direction. FIG. 8 is a cross-sectional view taken along the line VIII-VIII of FIG. 7. Each direction of the head chip 8 will be described based on the directions when mounted on the liquid ejecting head 2, that is, the X-axis direction, the Y-axis direction, and the Z-axis direction.

As illustrated in FIGS. 6 to 8, the head chip 8 of the present embodiment includes the pressure chamber substrate 10. The pressure chamber substrate 10 is made of, for example, a silicon substrate, a glass substrate, an SOI substrate, or various ceramic substrates.

In the pressure chamber substrate 10, a plurality of pressure chambers 12 are disposed side by side along the X-axis direction. The plurality of pressure chambers 12 are disposed on a straight line along the X-axis direction such that positions in the Y-axis direction are the same. Two pressure chambers 12 adjacent to each other in the X-axis direction are partitioned by a partition wall. In the present embodiment, two pressure chamber rows, in which the pressure chambers 12 are disposed side by side along the X-axis direction, are provided in the Y-axis direction.

The communication plate 15 and the nozzle plate 20 are sequentially laminated on the surface of the pressure chamber substrate 10 facing the +Z direction.

The communication plate 15 is made of a plate-shaped member joined to a surface of the pressure chamber substrate 10 facing the +Z direction. The communication plate 15 is provided with a nozzle communication path 16 that makes the pressure chamber 12 and the nozzle 21 communicate with each other.

Further, the communication plate 15 is provided with a first manifold portion 17 and a second manifold portion 18, which constitute a part of a manifold 100 that serves as a common liquid chamber to which the plurality of pressure chambers 12 commonly communicate. The first manifold portion 17 is provided to penetrate the communication plate 15 in the Z-axis direction. Further, the second manifold portion 18 is provided to be open on the surface facing the +Z direction without penetrating the communication plate 15 in the Z-axis direction.

Furthermore, the communication plate 15 is provided with a supply communication path 19 that communicates with one end portion of the pressure chamber 12 in the Y-axis direction, independently for each pressure chamber 12. The supply communication path 19 communicates between the second manifold portion 18 and the pressure chambers 12 to supply the ink in the manifold 100 to the pressure chambers 12.

As such a communication plate 15, a silicon substrate, a glass substrate, an SOI substrate, various ceramic substrates, a metal substrate such as a stainless-steel substrate, or the like is used. It is preferable that the communication plate 15 is made of a material having substantially the same thermal expansion coefficient as the pressure chamber substrate 10. By using a material having substantially the same thermal expansion coefficient for the pressure chamber substrate 10 and the communication plate 15 in this way, thermal warpage caused by heat can be reduced due to the differences in the thermal expansion coefficients.

The nozzle plate 20 is joined to the surface of the communication plate 15 facing the +Z direction, that is, the surface opposite to the pressure chamber substrate 10.

The nozzle plate 20 has nozzles 21 formed therein, which communicate with each of the pressure chambers 12 through the nozzle communication path 16.

In the present embodiment, the plurality of nozzles 21 are disposed side by side in a row along the X-axis direction. In the present embodiment, two nozzle rows, in which the nozzles 21 are disposed side by side along the X-axis direction, are provided spaced apart in the Y-axis direction. The two rows of nozzle rows disposed side by side in the Y-axis direction may be disposed in a so-called staggered pattern in which the nozzles 21 constituting each row are disposed in a state of being half-pitch shifted from each other in the X-axis direction. As such a nozzle plate 20, a silicon substrate, a glass substrate, an SOI substrate, various ceramic substrates, a metal substrate such as a stainless-steel substrate, an organic material such as a polyimide resin, and the like are used. It is preferable to use a material for the nozzle plate 20 that is substantially the same as the thermal expansion coefficient as the communication plate 15. By using a material having substantially the same thermal expansion coefficient for the nozzle plate 20 and the communication plate 15 in this way, thermal warpage caused by heat can be reduced due to the differences in the thermal expansion coefficients. The surface of the nozzle plate 20 facing the +Z direction where the nozzle 21 opens is referred to as a nozzle surface 20a.

A diaphragm 50 and a piezoelectric actuator 300 are sequentially laminated on the surface of the pressure chamber substrate 10 facing the -Z direction.

In the present embodiment, the diaphragm 50 includes an elastic film 51, which is made of silicon oxide, provided on the pressure chamber substrate 10 side, and an insulating film 52, which is made of a zirconium oxide, provided on the surface of the elastic film 51 facing the -Z direction. The diaphragm 50 may include only the elastic film 51 or only the insulating film 52 and may be configured to have other films in addition to the elastic film 51 and the insulating film 52. Further, the pressure chamber substrate 10 may be etched in the -Z direction from the +Z direction facing surface thereof to form a recessed portion as the pressure chamber 12. In this case, since a bottom surface of the recessed portion serves as the elastic film 51, the pressure chamber substrate 10 and the elastic film 51, which is a part of the diaphragm 50, are integrally formed. Further, the entire diaphragm 50 and the pressure chamber substrate 10 may be integrally formed.

The piezoelectric actuator 300 includes a first electrode 60, a piezoelectric layer 70, and a second electrode 80 that are sequentially laminated on the diaphragm 50 in the -Z direction. Such a piezoelectric actuator 300 is also called a piezoelectric element and refers to a part including the first electrode 60, the piezoelectric layer 70, and the second electrode 80. In addition, a part where piezoelectric strain occurs in the piezoelectric layer 70 when a voltage is applied between the first electrode 60 and the second electrode 80 is referred to as an active portion 310. Meanwhile, a part where piezoelectric strain does not occur in the piezoelectric layer 70 is referred to as an inactive portion. That is, the active portion 310 refers to a part where the piezoelectric layer 70 is interposed between the first electrode 60 and the second electrode 80. In the present embodiment, the active portion 310 is formed for each pressure chamber 12. That is, a plurality of active portions 310 are disposed side by side in the X-axis direction in the piezoelectric actuator 300. The plurality of active portions 310 serve as drive elements that cause a pressure change in the ink in the pressure chamber 12. In general, one of the electrodes of the active portion 310 is configured as an independent individual electrode for each active portion 310, and the other electrode is configured as a common electrode common to the plurality of active portions 310. In the present embodiment, the first electrode 60 is configured as an individual electrode, and the second electrode 80 is configured as a common electrode. It is needless to say that the first electrode 60 may form a common electrode, and the second electrode 80 may form an individual electrode.

The piezoelectric layer 70 is configured by using a piezoelectric material made of a perovskite structure composite oxide represented by the general formula ABO₃.

In addition, a lead electrode 90, which is a lead wiring, is drawn out from the first electrode 60. The flexible substrate 110, which is a flexible substrate, is coupled to the end portion of the lead electrode 90 on the opposite side from the end portion coupled to the piezoelectric actuator 300. The flexible substrate 110 is mounted with a drive circuit 111 having a plurality of switching elements for selecting whether to drive each of the active portions 310. That is, the flexible substrate 110 is made of COF. In the present embodiment, a surface of the flexible substrate 110 on which the drive circuit 111 is not mounted is referred to as a first surface 110a, and a surface on which the drive circuit 111 is mounted is referred to as a second surface 110b. The flexible substrate 110 may not be provided with the drive circuit 111. That is, the flexible substrate 110 may be an FFC, an FPC, or the like.

Each layer of the piezoelectric actuator 300 including the first electrode 60, the piezoelectric layer 70, and the second electrode 80 is formed by a film forming method and a lithography method. Therefore, the piezoelectric actuator 300 of the present embodiment is a piezoelectric thin film including the piezoelectric layer 70 which is a “thin film piezoelectric body”. Here, the piezoelectric thin film including the thin film piezoelectric body refers to a film having a thickness of less than 10μm in the Z-axis direction, which is the lamination direction, including the first electrode 60, the piezoelectric layer 70, and the second electrode 80. The piezoelectric thin film preferably has a thickness equal to or less than 3μm in order to dispose the plurality of nozzles 21 at a high density.

The protective substrate 30 having substantially the same size as the pressure chamber substrate 10 is laminated on the surface of the pressure chamber substrate 10 facing the -Z direction via the diaphragm 50. The phrase "the protective substrate is laminated on the pressure chamber substrate" means both that the protective substrate 30 is indirectly laminated on the pressure chamber substrate 10 via the diaphragm 50, and that the protective substrate 30 is directly laminated on a member where a part or all of the diaphragm 50 is integrally formed with the pressure chamber substrate 10. The protective substrate 30 has a holding portion 31 that is a space that protects the piezoelectric actuator 300. The holding portion 31 is independently provided for each row of the piezoelectric actuators 300 disposed side by side in the X-axis direction, and two holding portions 31 are formed side by side in the Y-axis direction. The protective substrate 30 is provided with a through-hole 32 penetrating in the Z-axis direction between the two holding portions 31 disposed side by side in the Y-axis direction. An end portion of the lead electrode 90 drawn out from the electrode of the piezoelectric actuator 300 is extended to be exposed in the through-hole 32, and the lead electrode 90 and the flexible substrate 110 are electrically coupled to each other in the through-hole 32.

As such a protective substrate 30, for example, a substrate made of a silicon substrate, a glass substrate, an SOI substrate, or various ceramic substrates is used similarly to the pressure chamber substrate 10. It is preferable that the protective substrate 30 is made of a material having substantially the same thermal expansion coefficient as the pressure chamber substrate 10. By using a material having substantially the same thermal expansion coefficient for the pressure chamber substrate 10 and the protective substrate 30 in this way, thermal warpage caused by heat can be reduced due to the differences in the thermal expansion coefficients.

In addition, the case member 40 is joined to the surface of the communication plate 15 facing the -Z direction via an adhesive (not illustrated). The case member 40 has substantially the same shape as the communication plate 15 described above in a plan view and is joined to the communication plate 15 at a position different from a position of the pressure chamber substrate 10. That is, the joining region in which the case member 40 and the communication plate 15 are joined to each other when viewed in the +Z direction is a position that does not overlap the pressure chamber substrate 10.

The case member 40 has a recessed portion 41 having a depth for accommodating the pressure chamber substrate 10 and the protective substrate 30 on the protective substrate 30 side. The recessed portion 41 has an opening area wider than the surface of the protective substrate 30 joined to the pressure chamber substrate 10. With the pressure chamber substrate 10 and the protective substrate 30 accommodated in the recessed portion 41, the opening surface of the recessed portion 41 on the nozzle plate 20 side is sealed by the communication plate 15. In the recessed portion 41, the lower surface 40a of the case member 40 facing the +Z direction and the upper surface 30a of the protective substrate 30 facing the -Z direction are disposed in the Z-axis direction with a gap without being adhered to each other. Here, the "gap" refers to a gap of 1μm or more. Further, the gap between the lower surface 40a and the upper surface 30a is preferably 50μm or more, taking into account manufacturing errors of the case member 40 and the protective substrate 30. By setting the gap to 50μm or more, even when manufacturing errors occur in the case member 40 or the protective substrate 30, contact between the lower surface 40a and the upper surface 30a can be suppressed. The lower surface 40a of the present embodiment is the bottom surface of the recessed portion 41 positioned in the -Z direction. By disposing the lower surface 40a of the case member 40 and the upper surface 30a of the protective substrate 30 with a gap without adhering the lower surface 40a of the case member 40 and the upper surface 30a of the protective substrate 30 in this way, the influence of deformation of the case member 40 transmitted to the protective substrate 30 can be suppressed. By the way, when the upper surface 30a of the protective substrate 30 and the lower surface 40a of the case member 40 are adhered, an influence of deformation of the case member 40, which is caused by a difference in linear expansion coefficients between the protective substrate 30 and the case member 40, is transmitted to the protective substrate 30, which may damage the piezoelectric actuator 300 on the diaphragm 50 adhered to the protective substrate 30. The pressure chamber substrate 10, the communication plate 15, the protective substrate 30, and the nozzle plate 20 are materials that have a smaller linear expansion coefficient than the case member 40 and are prone to cracking. In the present embodiment, by not adhering the upper surface 30a of the protective substrate 30 and the lower surface 40a of the case member 40, damage to the piezoelectric actuator 300 can be suppressed without transmitting the influence of deformation of the case member 40, which is caused by the difference in linear expansion coefficients between the protective substrate 30 and the case member 40, to the protective substrate 30.

The case member 40 is also provided with a third manifold portion 42 that communicates with the first manifold portion 17 of the communication plate 15. The first manifold portion 17 and the second manifold portion 18 provided in the communication plate 15 and the third manifold portion 42 provided in the case member 40 form the manifold 100 of the present embodiment. The manifolds 100 are provided in each row of the pressure chambers 12, that is, in a total of two. Each manifold 100 is continuously provided in the X-axis direction in which the pressure chambers 12 are disposed side by side, and the supply communication paths 19 that communicate each of the pressure chambers 12 and the manifold 100 are disposed side by side in the X-axis direction. The case member 40 also has an inlet 44a that communicates with the manifolds 100 to supply ink to each manifold 100. Further, the case member 40 has an opening portion 43 which communicates with the through-hole 32 of the protective substrate 30 and through which the flexible substrate 110 is inserted. The flexible substrate 110 is led out to the surface side of the liquid ejecting head 2 facing the -Z direction via the through-hole 32 and the opening portion 43. The width of the opening portion 43 in the Y-axis direction is wider than the width of the through-hole 32 of the protective substrate 30 in the Y-axis direction. For this reason, the surface of the protective substrate 30 on the central position side in the Y-axis direction facing the -Z direction is exposed within the opening portion 43 without being covered by the case member 40.

Further, the case member 40 has an accommodation portion 45 that has a recessed shape that opens on the surface facing the -Z direction. As illustrated in FIG. 6, the accommodation portion 45 is provided to open on one side in the Y-axis direction and on both sides in the X-axis direction. Into this accommodation portion 45, a flange portion 252 (see FIG. 2) of the relay member 250, which will be described in detail later, is inserted. For this reason, when viewed in the +Z direction, the accommodation portion 45 has substantially the same shape as the flange portion 252, and the depth of the accommodation portion 45 in the Z-axis direction is deeper than the thickness of the flange portion 252 in the Z-axis direction. Therefore, the surface of the flange portion 252 facing the +Z direction is disposed with a gap from the upper surface of the accommodation portion 45 of the case member 40 facing the -Z direction. Here, the "gap" refers to a gap of 1μm or more. As a result, the contact portion 256 of the relay member 250 and the upper surface 30a of the protective substrate 30 can be reliably brought into contact. By the way, the inlet 44a is disposed in a part where the accommodation portion 45 is not provided. As such a case member 40, a metal material, a resin material, or the like is used.

A compliance substrate 120 is provided on the surface of the communication plate 15 on the +Z direction side where the first manifold portion 17 and the second manifold portion 18 are open. The compliance substrate 120 seals the openings of the first manifold portion 17 and the second manifold portion 18 on the nozzle surface 20a side. In the present embodiment, such a compliance substrate 120 includes a sealing film 121 made of a flexible thin film, and a fixing substrate 122 made of a hard material such as metal. Since the region of the fixing substrate 122 facing the manifold 100 becomes an opening portion 123 completely removed in the thickness direction, one surface of the manifold 100 becomes a compliance portion 124, which is a flexible portion sealed only by the flexible sealing film 121.

The fixing plate 240, which will be described in detail later, is joined to the surface of the compliance substrate 120 facing the +Z direction. That is, the fixing plate 240 is joined to the fixing substrate 122 to cover the opening portion 123. The space between the fixing plate 240 and the sealing film 121 is opened to the atmosphere, thereby making the compliance portion 124 of the sealing film 121 deformable in accordance with the pressure of ink in the manifold 100.

Further, a filler 22 is filled between the nozzle plate 20 and an exposure opening portion 241 of the compliance substrate 120 and the fixing plate 240. As the filler 22, an adhesive, a potting agent, a molding agent, or the like can be used. By filling the filler 22 into the gap between the nozzle plate 20 and the fixing plate 240, ink from wiping the nozzle surface 20a with a blade can be suppressed from accumulating in the gap. In addition, it is possible to suppress the blade, which is wiped by the filler 22, from abutting against the corner portion of the nozzle plate 20 and scraping the blade, and it is possible to suppress a decrease in the lifespan of the blade.

As illustrated in FIGS. 2 to 5, the holder 200, the coupling flow path member 210, and the seal member 220 have a supply flow path for supplying the ink supplied from the liquid storage portion 3 to the head chip 8 as the flow path 400, and a discharge flow path for returning the ink not ejected from the nozzle 21 of the head chip 8 to the liquid storage portion 3. FIG. 3 illustrates only the supply flow path as the flow path 400, and the flow path 400, which is the supply flow path, will be described below.

The holder 200, the seal member 220, and the coupling flow path member 210 are laminated in the -Z direction in this order. The holder 200 has a first flow path 401, the coupling flow path member 210 has a second flow path 402, and the first flow path 401 and the second flow path 402 are coupled in a liquid-tight state by the seal member 220.

In the present embodiment, the coupling flow path member 210 is configured with three members 211, 212, and 213 laminated in the +Z direction in this order. The coupling flow path member 210 has a supply-side flow path coupling portion 214a coupled to the liquid storage portion 3 in which liquid ink is stored. In the present embodiment, as the supply-side flow path coupling portion 214a, a portion protruding in a cylindrical shape in the -Z direction is formed on the surface of the coupling flow path member 210 in the -Z direction. The supply tube 7d is coupled to the supply-side flow path coupling portion 214a. Within the supply-side flow path coupling portion 214a, a second flow path 402, through which ink is supplied from the liquid storage portion 3, is provided.

The second flow path 402 is configured with a flow path extending in the Z-axis direction, a flow path extending along a laminated interface of laminated members, or the like. Further, in the middle of the second flow path 402, a filter chamber 402a, whose inner diameter is wider and expanded than other regions, is provided, and within the filter chamber 402a, a filter 402b for catching foreign matter such as dust and air bubbles contained in ink is provided.

In the present embodiment, one coupling flow path member 210 includes four supply-side flow path coupling portions 214a and four independent second flow paths 402. The second flow path 402 may branch into two or more, for example, downstream of the filter 402b.

In addition, as illustrated in FIG. 2, the coupling flow path member 210 has four discharge-side flow path coupling portions 214b. The recovery tube 7c (see FIG. 1) is coupled to each discharge-side flow path coupling portion 214b, and the ink that is not ejected from the nozzle 21 of the liquid ejecting head 2 is returned to the sub tank 3b via the recovery tube 7c. Further, a discharge flow path is provided inside the discharge-side flow path coupling portion 214b (not illustrated). That is, the holder 200 is provided with four discharge flow paths (not illustrated). By the way, there is no need to provide a filter in the middle of the discharge flow path. Hereinafter, when the supply-side flow path coupling portion 214a and the discharge-side flow path coupling portion 214b are not distinguished, the sections are referred to as a flow path coupling portion 214.

The holder 200 has the first flow path 401 communicating with each of the second flow paths 402 of the coupling flow path member 210. That is, the holder 200 has four first flow paths 401. The first flow path 401 and the second flow path 402 are coupled in a liquid-tight manner via the seal member 220. The seal member 220 has liquid resistance to liquid such as ink used in the liquid ejecting head 2 and an elastically deformable material, for example, rubber, elastomer or the like may be used. Such a seal member 220 is provided with a communication flow path 403 penetrating in the Z-axis direction, and the first flow path 401 and the second flow path 402 communicate via the communication flow path 403. That is, the flow path 400, which is a supply flow path of the holder 200, includes the first flow path 401, the second flow path 402, and the communication flow path 403.

Further, the head chip 8 is held on the surface of the holder 200 facing the +Z direction. Specifically, the holder 200 has a head chip accommodation portion 201 having a recessed shape that opens on the surface facing the +Z direction, and the head chip 8 is held within the head chip accommodation portion 201. In the liquid ejecting head 2 of the present embodiment, a plurality of head chips 8, specifically two head chips 8 as an example in the present embodiment, are held. In the present embodiment, the head chip accommodation portion 201 is independently provided for each head chip 8. That is, the holder 200 has two head chip accommodation portions 201. It is needless to say that the head chip accommodation portion 201 may be commonly provided across the plurality of head chips 8. The number of head chips 8 held by the liquid ejecting head 2 is not particularly limited thereto, and may be one, or a plurality of two or more. In the present embodiment, the two head chips 8 are disposed side by side in the Y-axis direction to be at the same position in the X-axis direction. It is needless to say that the disposition of the plurality of head chips 8 is not particularly limited thereto, and may be, for example, disposed in a staggered pattern along the X-axis direction. Such a holder 200 is formed of metal or resin.

In addition, the bottom surface of the head chip accommodation portion 201 facing the +Z direction and the surface of the head chip 8 facing the -Z direction are disposed with a gap therebetween. Here, the "gap" refers to a gap of 1μm or more. The first flow path 401 communicates with each inlet 44a of the head chip 8. In the present embodiment, the first flow path 401 and each inlet 44a are communicated with each other in a liquid-tight manner by an adhesive 130 provided in the gap between the holder 200 and the head chip 8. That is, the adhesive 130 is provided to surround the entire circumference of the opening of the inlet 44a formed on the surface of the head chip 8 facing the -Z direction, when viewed in the +Z direction, and the adhesive 130 is also provided to surround the entire circumference of the opening of the first flow path 401 formed on the surface of the holder 200 facing the +Z direction, when viewed in the -Z direction. As such an adhesive 130, an adhesive with high resistance to the liquid used in the liquid ejecting head 2, that is, an adhesive with high liquid resistance, such as an epoxy-based adhesive, is used. Further, the adhesive 130 may be a silicone-based adhesive having a viscosity that allows the gap to be filled before curing, has relatively low curing shrinkage, and is relatively soft after curing. When the viscosity of the adhesive 130 before curing is too low, the adhesive 130 tends to flow out from the gap, which is not preferable. Moreover, when the adhesive 130 with relatively large curing shrinkage is used, there is a risk of positional deviation occurring in the Z-axis direction between the plurality of head chips 8 due to the curing shrinkage of the adhesive 130, but by using a relatively soft adhesive as the adhesive 130 after curing, positional deviation between the head chips 8 due to the curing shrinkage of the adhesive 130 can be suppressed. The discharge flow path (not illustrated) of the holder 200 is coupled to an outlet 44b of the head chip 8. The outlet 44b and the discharge flow path have the same configuration.

In addition, the holder 200 is provided with a wiring holding hole 202 for inserting the flexible substrate 110 of each head chip 8. In the present embodiment, a total of two wiring holding holes 202 are provided, by being independently provided for each head chip 8. The flexible substrate 110 of the head chip 8, which will be described in detail later, is led out to the surface side of the holder 200 facing the -Z direction via the wiring holding hole 202.

Further, in the Z-axis direction, a relay substrate 230, to which the flexible substrates 110 of the plurality of head chips 8 are commonly coupled, is provided between the seal member 220 and the coupling flow path member 210. The relay substrate 230 is made of a rigid, non-flexible substrate, and is mounted with wiring, electronic components, and the like (not illustrated). In the present embodiment, a connector 231 to which external wiring is coupled is illustrated as an electronic component. Print signals and the like for controlling the head chip 8 are input to the relay substrate 230 from external wiring via the connector 231 and supplied from the relay substrate 230 to each head chip 8. An external wiring opening portion 203 for inserting external wiring coupled to the connector 231 is provided on a side wall of the holder 200 opposite to the connector 231. The external wiring is coupled to the connector 231 of the relay substrate 230 provided inside the holder 200 via the external wiring opening portion 203.

The relay substrate 230 is provided with a wiring insertion hole 232 for leading out the flexible substrate 110 of the head chip 8 to the surface side facing the -Z direction. Two wiring insertion holes 232 are provided in total, one for each head chip 8.

Further, the relay substrate 230 is provided with a protrusion insertion hole 233 that penetrates in the Z-axis direction. A protrusion portion 204, in which the first flow path 401 is provided, is provided to protrude in the -Z direction on the surface of the holder 200 facing the -Z direction, and the protrusion portion 204 is inserted into the -Z direction side of the relay substrate 230 via the protrusion insertion hole 233 and is coupled to communication flow path 403.

Further, the fixing plate 240 is fixed to the surface of the holder 200 facing the +Z direction where the head chip accommodation portion 201 opens. The fixing plate 240, in the present embodiment, has a size to cover the two head chips 8. The fixing plate 240 is independently provided with the exposure opening portion 241 for each head chip 8, which exposes the nozzle 21 of the head chip 8 in the +Z direction. Ink is ejected in the +Z direction from the nozzle 21 exposed from the exposure opening portion 241. It is needless to say that the exposure opening portion 241 may be commonly provided for the plurality of head chips 8.

As illustrated in FIGS. 3 to 5, the relay member 250 is a member that is inserted into the opening portion 43 of the case member 40 of the head chip 8 and does not define a flow path through which ink flows. The relay member 250 includes a base portion 251 and a flange portion 252.

The base portion 251 is a cylindrical member that has a rectangular shape when viewed in the +Z direction and has an opening portion 253 penetrating through the Z-axis direction. That is, the opening portion 253 is provided inside the base portion 251, which is annularly continuous when viewed in the +Z direction. The flexible substrate 110 is inserted through this opening portion 253.

The flange portion 252 is provided at an end portion of the base portion 251 in the -Z direction, extending from the base portion 251 along an XY plane defined by an X-axis and a Y-axis. The flange portion 252 has notch portions 254 at respective end portions in the X-axis direction, at positions overlapping the inlet 44a and the outlet 44b when viewed in the +Z direction.

In such a relay member 250, the surface of the flange portion 252 facing the -Z direction is fixed to the lower surface 200a of the holder 200 facing the +Z direction. The lower surface 200a of the holder 200 facing the +Z direction is the bottom surface of the head chip accommodation portion 201 in the present embodiment. That is, the end portion on the outer peripheral side of the flange portion 252 forms a supported portion 255 which is supported by the holder 200. The surface 255a of the supported portion 255 facing the -Z direction is fixed to the lower surface 200a of the holder 200. In the present embodiment, the flange portion 252 and the holder 200 are adhered via an adhesive 260. As the adhesive 260, for example, a high-temperature curing type epoxy resin is preferably adopted, but the present disclosure is not limited thereto. It is needless to say that the method of fixing the supported portion 255 of the flange portion 252 and the holder 200 is not limited to adhering. For example, the supported portion 255 of the flange portion 252 and the holder 200 may be fixed by brazing such as soldering or brazing, welding, or thermal bonding.

In addition, the end portion of the base portion 251 of the relay member 250 in the +Z direction is the contact portion 256 that contacts the upper surface 30a of the protective substrate 30 in the -Z direction. That is, a surface 256a of the contact portion 256 of the base portion 251 facing the +Z direction contacts the upper surface 30a. The surface 256a of the relay member 250 contacts the upper surface 30a of the protective substrate 30 but is not adhered. Two surfaces being in contact indicates that at least a portion of the two surfaces is in contact. That is, both a configuration in which the two surfaces are in point contact at one or a plurality of points, and a configuration in which the two surfaces are in surface contact are included.

The relay member 250 is formed of metal or resin. By forming the relay member 250 from metal, the rigidity of the relay member 250 can be enhanced. Further, by forming the relay member 250 from resin, conduction between the drive circuit 111 and the relay member 250 can be suppressed, and electrical defects due to conduction between the drive circuit 111 and the relay member 250 can be suppressed. In addition, the relay member 250 may have a mixture of parts formed from resin and parts formed from metal. For example, when the opening portion 253 side of the base portion 251 is formed from resin, and other parts of the base portion 251 and the flange portion 252 are formed from metal, the rigidity of the relay member 250 can be enhanced, and conduction between the drive circuit 111 and the relay member 250 can be suppressed. In addition, the base portion 251 may be formed from metal, and an insulating film may be provided on the inner peripheral surface of the opening portion 253.

Such a relay member 250 restricts the movement of the protective substrate 30 in the -Z direction, with the supported portion 255 supported by the holder 200, by the contact portion 256 contacting the upper surface 30a of the protective substrate 30.

As described above, when the influence of deformation of the case member 40, caused by the difference in linear expansion coefficients between the protective substrate 30 and the case member 40, is transmitted to the protective substrate 30, there is a risk of damaging the piezoelectric actuator 300 on the diaphragm 50 adhered to the protective substrate 30. For this reason, when the protective substrate 30 and the case member 40 are disposed with a gap therebetween and are not adhered to each other as in the present embodiment, an external force is applied to the liquid ejecting head 2 in the -Z direction, which is the direction opposite to the ink ejecting direction, when the medium contacts the nozzle surface 20a or the fixing plate 240 of the liquid ejecting head 2 due to a medium S transport failure, such as a paper jam. At this time, as illustrated in FIG. 5, the communication plate 15 may deform in the direction indicated by the dotted line to narrow the gap between the protective substrate 30 and the case member 40, with the inner end portion in the Y-axis direction (the position indicated by the arrow in FIG. 5) of the joint surface between the fixing plate 240 and the holder 200 as a fulcrum, potentially causing the communication plate 15 to crack. Further, since the holder 200 and the case member 40 are adhered with the relatively soft adhesive 130, the communication plate 15 may deform in the direction indicated by the dotted line as if the adhesive 130 is crushed, potentially causing the communication plate 15 to crack. In addition, when the rigidity of the fixing plate 240 is relatively high, or when a reinforcing plate or the like is disposed between the fixing plate 240 and the holder 200, the communication plate 15 deforms in the direction indicated by the dotted line, using the joint surface between the fixing plate 240 or the reinforcing plate and the compliance substrate 120, that is, the inner end portion in the Y-axis direction of the fixing substrate 122, as a fulcrum. By the way, the reinforcing plate constitutes a part of the holder 200.

In the present embodiment, by providing the relay member 250, which is supported by the holder 200 and contacts the upper surface 30a of the protective substrate 30, the holder 200 can restrict the movement of the protective substrate 30 in the -Z direction via the relay member 250, even when an external force towards the -Z direction is applied to the liquid ejecting head 2. Therefore, by the holder 200 restricting the movement of the protective substrate 30 in the -Z direction via the relay member 250, deformation of the communication plate 15 into a convex shape in the -Z direction can be suppressed, and the communication plate 15 can be suppressed from cracking. In particular, in the present embodiment, the supported portion 255 of the relay member 250 is fixed to the lower surface 200a of the holder 200 facing the +Z direction. For this reason, because the lower surface 200a of the holder 200 facing the +Z direction can restrict the movement of the relay member 250 in the -Z direction, it is easy to suppress the movement of the protective substrate 30 due to deformation of the communication plate 15. Further, by providing the relay member 250 with the flange portion 252 and fixing the surface of the flange portion 252 facing the -Z direction to the holder 200, the pressure-receiving area that the holder 200 receives from the relay member 250 can be made relatively larger compared to a case where the flange portion 252 is not provided. As a result, deformation of the holder 200 itself can be suppressed, and cracking due to deformation of the communication plate 15 can be suppressed. Moreover, the opening portion 253 is provided inside the base portion 251 that is annularly continuous when viewed in the +Z direction, thereby improving the rigidity of the base portion 251, suppressing deformation of the base portion 251 due to an external force, and further suppressing deformation of the communication plate 15. Further, the holder 200 of the present embodiment is a relatively rigid member that holds the plurality of head chips 8, specifically two head chips 8 in the present embodiment. For this reason, by having the protective substrate 30 abut against the relatively rigid holder 200 via the relay member 250, instead of having the protective substrate 30 abut against the case member 40, as in the present embodiment, deformation of the communication plate 15 can be further suppressed.

By the way, even when an attempt is made to bring the lower surface 40a of the recessed portion 41 of the case member 40 into contact with the upper surface 30a of the protective substrate 30 without adhering the lower surface 40a of the recessed portion 41 of the case member 40 to the upper surface 30a of the protective substrate 30 and without providing the relay member 250, a gap will be formed between the communication plate 15 and the case member 40 due to manufacturing errors in the case member 40 or the like, or a load in the +Z direction will be applied to the protective substrate 30 by adhering the communication plate 15 and the case member 40 without a gap. In the present embodiment, by providing a gap between the lower surface 40a of the recessed portion 41 of the case member 40 and the upper surface 30a of the protective substrate 30, even when manufacturing errors occur in the case member 40 or the like, the case member 40 and the communication plate 15 can be adhered without a gap, and the application of a load in the +Z direction to the protective substrate 30 by the case member 40 can be suppressed.

Further, by not adhering the relay member 250 to the protective substrate 30, the protective substrate 30 does not receive the influence of deformation of the holder 200 or the relay member 250 due to the difference in linear expansion coefficients between the holder 200 or the relay member 250 and the protective substrate 30, thereby suppressing damage to the piezoelectric actuator 300.

Further, in the present embodiment, the relay member 250 is configured such that the surface 256a of the contact portion 256 of the base portion 251 facing the +Z direction and the upper surface 30a of the protective substrate 30 facing the -Z direction are in contact at a position inward of the center position between the inner peripheral surface of the through-hole 32 of the protective substrate 30 and the outer peripheral surface of the protective substrate 30, when viewed in the +X direction. The central side of the protective substrate 30 in the Y-axis direction is the part where the amount of deformation of the communication plate 15 is largest due to an external force applied to the liquid ejecting head 2. For this reason, by the relay member 250 contacting the protective substrate 30 on the part side where the amount of deformation of the communication plate 15 is large, the deformation of the communication plate 15 in the -Z direction can be effectively suppressed by the relay member 250.

Further, in the present embodiment, the case member 40 has the accommodation portion 45 with a recessed shape that opens on the surface facing the -Z direction, and the flange portion 252 of the relay member 250 is accommodated within the accommodation portion 45. For this reason, the liquid ejecting head 2 is suppressed from becoming larger in the Z-axis direction, and the liquid ejecting head 2 can be miniaturized in the Z-axis direction.

In the present embodiment, the +Z direction is an example of a “first direction”, and the -Z direction is an example of a “second direction”. In addition, the communication plate 15 is an example of a "first flow path member", and any or all of the nozzle communication path 16 of the communication plate 15, the first manifold portion 17, the second manifold portion 18, and the supply communication path 19 are examples of a "flow path communicating with the nozzle 21". Further, the case member 40 is an example of a "second flow path member", and the third manifold portion 42 is an example of a "flow path communicating with the flow path of the first flow path member". In addition, one of the two head chips 8 is an example of a "first head chip", and the other is an example of a "second head chip".

### Modification Example

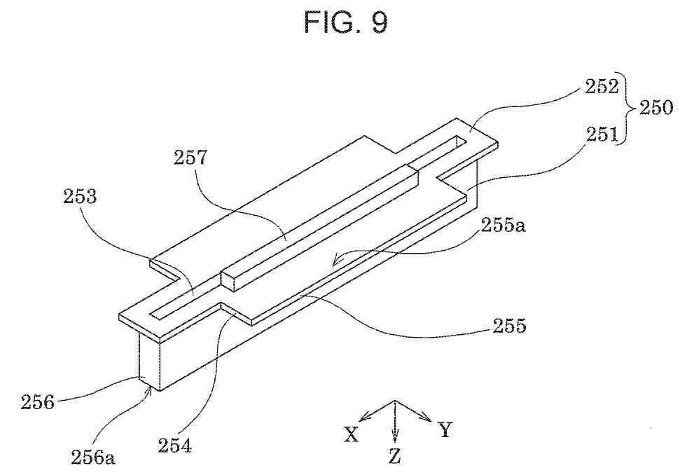

FIG. 9 is a perspective view illustrating a modification example of the relay member 250 according to Embodiment 1 of the present disclosure.

As illustrated in FIG. 9, the relay member 250 has a rib 257 that protrudes in the -Z direction on the surface of the flange portion 252 facing the -Z direction. The rib 257 extends across the X-axis direction on the +Y direction side of the opening portion 253 of the flange portion 252. In addition, the rib 257 is disposed to protrude further in the -Z direction than the surface 255a of the supported portion 255 facing the -Z direction. Such a rib 257 is inserted into the wiring holding hole 202 of the holder 200.

By providing the relay member 250 with the rib 257 in this way, the rigidity of the relay member 250, particularly the rigidity against deformation in the -Z direction in the X-axis direction, can be improved, and deformation of the communication plate 15 can be further suppressed. It is needless to say that the rib 257 may be provided on both sides of the opening portion 253 in the Y-axis direction, and the two ribs 257 provided on both sides of the opening portion 253 in the Y-axis direction may be coupled to be continuous on both sides of the opening portion 253 in the X-axis direction. That is, the rib 257 may be provided to be annularly continuous around the opening portion 253 when viewed in the +Z direction. This can further improve the rigidity of the relay member 250.

### Embodiment 2

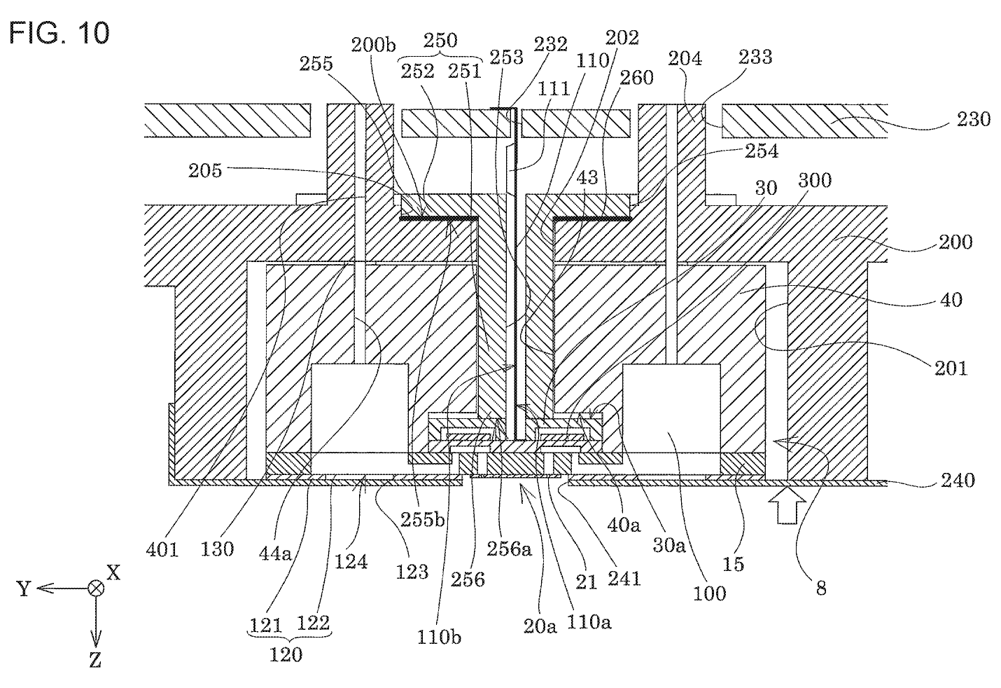

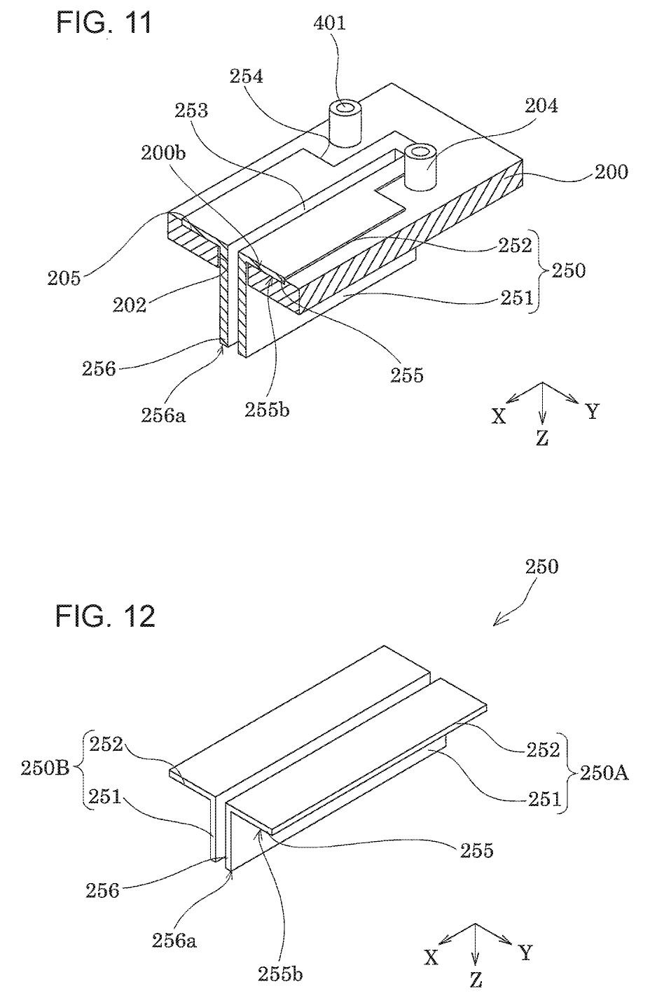

FIG. 10 is a cross-sectional view of the liquid ejecting head 2 according to Embodiment 2 of the present disclosure. FIG. 11 is a perspective view of the holder 200 and the relay member 250 according to Embodiment 2, with the main part of the holder and relay member cut out. Members that are the same as those in the above-described embodiment are denoted by the same reference numerals, and redundant descriptions are omitted.

As illustrated, the relay member 250 has the same shape as the above-described Embodiment 1. That is, the relay member 250 includes a base portion 251 and a flange portion 252.

In addition, the surface of the flange portion 252 of the relay member 250 facing the +Z direction is fixed to the upper surface 200b of the holder 200 facing the -Z direction. That is, in the present embodiment, the end portion on the outer peripheral side of the flange portion 252 is the supported portion 255 supported by the holder 200. A surface 255b of the supported portion 255 facing the +Z direction is fixed to the upper surface 200b of the holder 200. In the present embodiment, the surface 255b of the supported portion 255 of the flange portion 252 facing the +Z direction and the upper surface 200b of the holder 200 are adhered via the adhesive 260. The supported portion 255 of the flange portion 252 and the holder 200 are not limited to adhering with the adhesive 260 but may also be fixed by brazing such as soldering or brazing, welding, thermal bonding, or fastening with screws or the like. However, when a gap occurs between the surface 255b of the supported portion 255 facing the +Z direction and the upper surface 200b of the holder 200 due to manufacturing errors of the holder 200 or the relay member 250, fastening with screws is not preferable because the relay member 250 will move in the +Z direction by the amount of this gap, applying a load to the protective substrate 30 by the relay member 250. By adhering the holder 200 and the supported portion 255 with the adhesive 260, even when a gap occurs between the holder 200 and the supported portion 255, the gap can be filled with the adhesive 260, so both can be fixed to each other without applying a load to the protective substrate 30.

In addition, a recessed portion 205 is formed in a part where the supported portion 255 of the holder 200 is fixed, the recessed portion 205 being more recessed in the +Z direction than other regions. The recessed portion 205 has a shape matching the outer shape of the flange portion 252 when viewed in the +Z direction, and by inserting the supported portion 255 of the flange portion 252 into the recessed portion 205, the relay member 250 can be positioned with high precision on the XY plane with respect to the holder 200. That is, by having the side surface of the recessed portion 205 and the outer peripheral surface of the flange portion 252 abut against each other, the relay member 250 is positioned in the XY plane with respect to the holder 200. It is needless to say that positioning of the relay member 250 with respect to the holder 200 is not particularly limited thereto, and both may be positioned by providing a positioning pin that protrudes towards the other in one of the relay member 250 and the holder 200, providing a positioning hole in the other into which the positioning pin is inserted, and inserting the positioning pin into the positioning hole. It is preferable to provide two such positioning pins and positioning holes. This allows the relay member 250 to be positioned with high precision on the XY plane with respect to the holder 200.

In the present embodiment, the notch portions 254 are provided at the four corners of the flange portion 252 when viewed in the +Z direction. The notch portions 254 are disposed at positions overlapping the protrusion portion 204 when viewed in the +Z direction. This prevents interference between the protrusion portion 204 and the flange portion 252.

In such a liquid ejecting head 2, similar to the above-described Embodiment 1, the movement of the protective substrate 30 in the -Z direction is restricted by the holder 200 via the relay member 250. Therefore, even when an external force is applied to the liquid ejecting head 2 in the -Z direction from the liquid ejecting surface side, deformation of the communication plate 15 can be reduced, and the communication plate 15 can be suppressed from cracking.

Further, in the liquid ejecting head 2 of the present embodiment, the relay member 250 can be inserted into the wiring holding hole 202 from the upper surface 200b side of the holder 200 facing the -Z direction and fixed. Therefore, the relay member 250 and the holder 200 can be easily fixed. In addition, before fixing the relay member 250 to the holder 200, the head chip 8 and the fixing plate 240 can be fixed to the holder 200. That is, before fixing the relay member 250 to the holder 200, the holder 200 and the fixing plate 240, to which the plurality of head chips 8 are fixed, can be adhered and cured to position the plurality of head chips 8 with respect to the holder 200. For this reason, the fixing process between the relay member 250 and the holder 200 can be suppressed from affecting the positioning of the head chip 8 and the holder 200. Further, by fixing the supported portion 255 of the flange portion 252 to the upper surface 200b of the holder 200 facing the -Z direction, the gap between the case member 40 and the holder 200, that is, the gap between the surface of the case member 40 facing the -Z direction and the bottom surface of the head chip accommodation portion 201, can be reduced. Therefore, the height of the case member 40 can be increased by that much, and miniaturization of the manifold 100 can be suppressed.

Further, in the present embodiment, by providing the recessed portion 205 on the upper surface 200b of the holder 200 facing the -Z direction and fixing the supported portion 255 of the flange portion 252 within the recessed portion 205, miniaturization of the liquid ejecting head 2 in the Z-axis direction can be achieved. In the present embodiment, the relay member 250 in the XY plane is positioned by the recessed portion 205, but the present disclosure is not particularly limited thereto. For example, the recessed portion 205 may be provided with an opening larger than the outer shape of the flange portion 252. That is, the recessed portion 205 may not have a positioning function for the relay member 250. Further, in the present embodiment, the depth of the recessed portion 205 in the Z-axis direction is made smaller than the thickness of the flange portion 252 in the Z-axis direction, but the present disclosure is not particularly limited thereto, and by making the depth of the recessed portion 205 in the Z-axis direction larger than the thickness of the flange portion 252 in the Z-axis direction, further miniaturization of the liquid ejecting head 2 in the Z-axis direction can be achieved.

In the present embodiment, the +Z direction is an example of a “first direction”, and the -Z direction is an example of a “second direction”. In addition, the communication plate 15 is an example of a "first flow path member", and any or all of the nozzle communication path 16 of the communication plate 15, the first manifold portion 17, the second manifold portion 18, and the supply communication path 19 are examples of a "flow path communicating with the nozzle 21". Further, the case member 40 is an example of a "second flow path member", and the third manifold portion 42 is an example of a "flow path communicating with the flow path of the first flow path member". In addition, one of the two head chips 8 is an example of a "first head chip", and the other is an example of a "second head chip".

### Embodiment 3

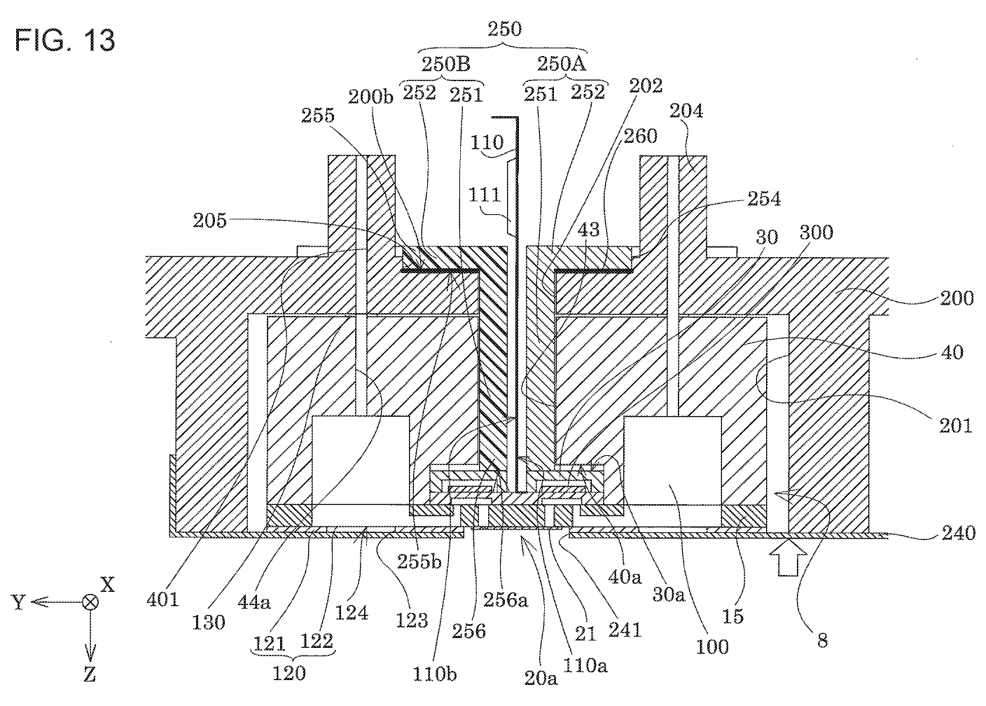

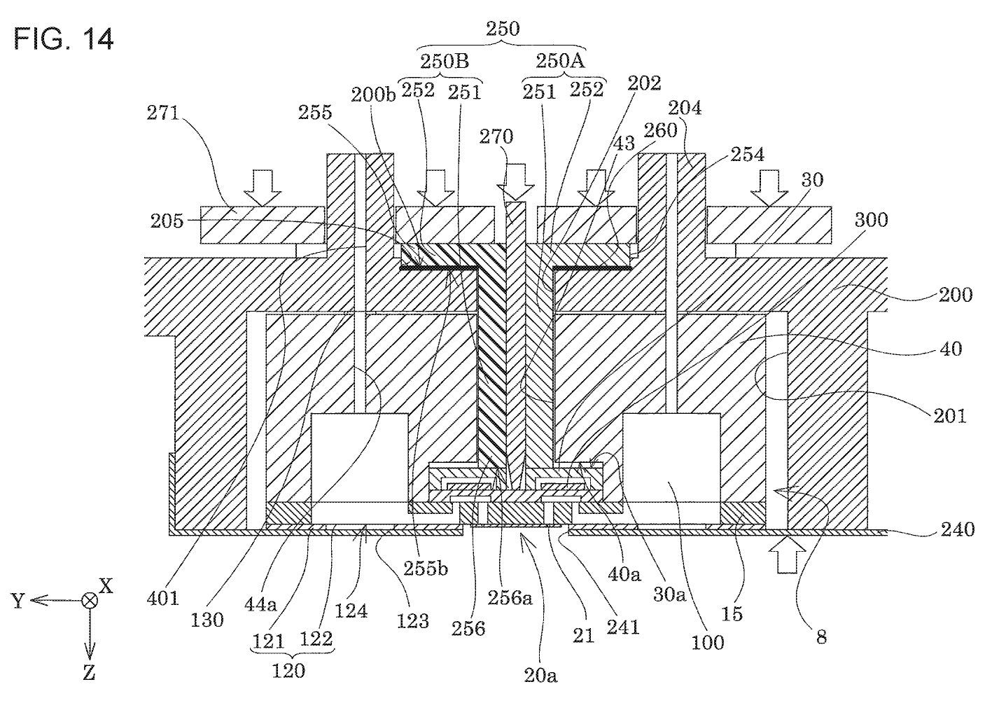

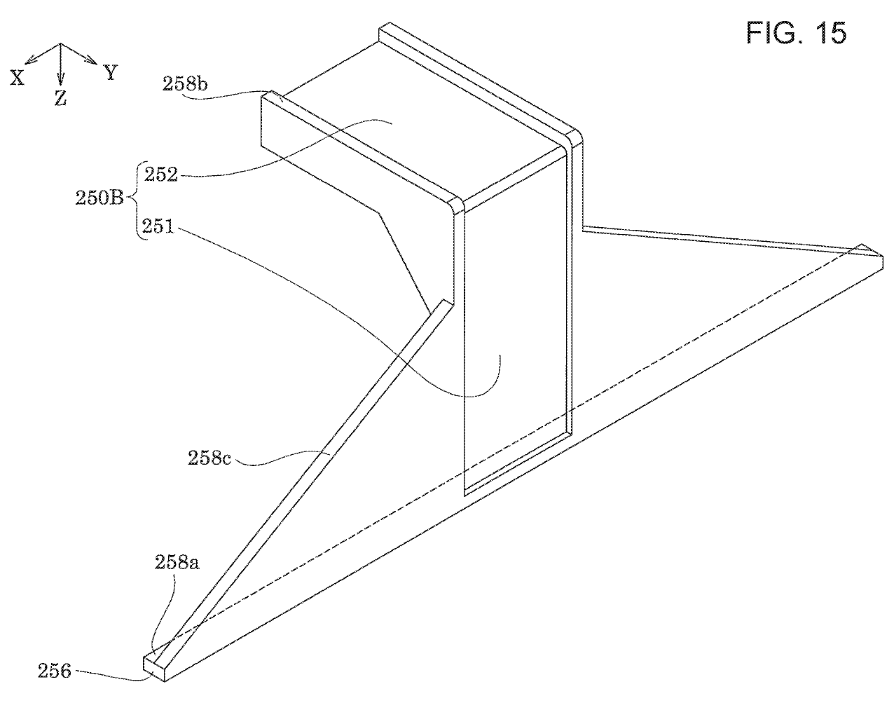

FIG. 12 is a perspective view of the relay member 250 according to Embodiment 3 of the present disclosure. FIG. 13 is a cross-sectional view of the liquid ejecting head 2 according to Embodiment 3. FIG. 14 is a cross-sectional view illustrating an assembly process of the liquid ejecting head 2 according to Embodiment 3.

As illustrated, the relay member 250 has a first member 250A facing the first surface 110a of the flexible substrate 110, and a second member 250B facing the second surface 110b of the flexible substrate 110.

The first member 250A and the second member 250B are two separated members and are not continuous.

The first member 250A and the second member 250B are made of members having the same shape, and the second member 250B is rotated by 180 degrees with respect to the first member 250A using an axis along the Z-axis direction as a rotation axis.

Each of the first member 250A and the second member 250B includes the plate-shaped base portion 251 along the XZ plane, and the plate-shaped flange portion 252 extending along the Y-axis direction from the end portion of the base portion 251 along the -Z direction. That is, each of the first member 250A and the second member 250B has a shape in which a plate-shaped member is bent by 90 degrees.

An end portion of the base portion 251 in the +Z direction is the contact portion 256 that contacts the upper surface 30a of the protective substrate 30, and the surface 256a of the contact portion 256 facing the +Z direction contacts the upper surface 30a without being adhered.

In addition, the end portion of the flange portion 252 on the side opposite to the base portion 251 is the supported portion 255 fixed to the holder 200, and the surface 255b of the supported portion 255 facing the +Z direction is fixed to the upper surface 200b of the holder 200. In the present embodiment, the surface 255b of the supported portion 255 facing the +Z direction and the upper surface 200b of the holder 200 are adhered via the adhesive 260, similar to Embodiment 2 described above. The supported portion 255 of the flange portion 252 and the holder 200 are not limited to adhering with the adhesive 260 but may also be fixed by brazing such as soldering or brazing, welding, thermal bonding, or fastening with screws or the like. Further, in the present embodiment as well, similar to Embodiment 2 described above, the recessed portion 205 is provided on the upper surface 200b of the holder 200, and the supported portion 255 is positioned within the recessed portion 205.

Even by using such a relay member 250, the same effects as those of Embodiment 2 described above can be obtained. Further, by configuring the relay member 250 with the separated first member 250A and the second member 250B, the flexible substrate 110 is disposed between the first member 250A and the second member 250B in the Y-axis direction. For this reason, when inserting the first member 250A and the second member 250B into the opening portion 43 of the case member 40 or into the wiring holding hole 202 of the holder 200, the first member 250A and the second member 250B can be inserted individually, making insertion easier and improving assemblability. Incidentally, when the first member 250A and the second member 250B are inserted into the wiring holding hole 202 of the holder 200, the base portion 251 may be in an orientation of being inclined in the Y-axis direction with respect to the Z-axis direction. Therefore, as illustrated in FIG. 14, by inserting a first jig 270 between the first member 250A and the second member 250B, the orientation of the first member 250A and the second member 250B may be such that the base portion 251 is disposed along the Z-axis with the opening portion closed. After correcting the orientation of the first member 250A and the second member 250B with the first jig 270, the flange portion 252 and the holder 200 may be adhered with the adhesive 260 by pressing the flange portion 252 in the +Z direction with a second jig 271. This allows each contact portion of the relay member 250 to make surface contact with the upper surface 30a of the protective substrate 30, thereby increasing the pressure-receiving area and suppressing deformation of the communication plate 15.

In addition, it is preferable that the first member 250A is formed of metal and the second member 250B is formed of resin. This is because the drive circuit 111 is mounted on the second surface 110b of the flexible substrate 110, and thus, by forming the second member 250B from resin, conduction between the second member 250B and the drive circuit 111 can be suppressed, thereby suppressing electrical defects due to conduction between the drive circuit 111 and the second member 250B. Further, by forming the first member 250A from metal, the rigidity of the first member 250A can be improved, and deformation of the communication plate 15 can be further suppressed.

In the present embodiment, the +Z direction is an example of a “first direction”, and the -Z direction is an example of a “second direction”. In addition, the communication plate 15 is an example of a "first flow path member", and any or all of the nozzle communication path 16 of the communication plate 15, the first manifold portion 17, the second manifold portion 18, and the supply communication path 19 are examples of a "flow path communicating with the nozzle 21". Further, the case member 40 is an example of a "second flow path member", and the third manifold portion 42 is an example of a "flow path communicating with the flow path of the first flow path member". In addition, one of the two head chips 8 is an example of a "first head chip", and the other is an example of a "second head chip".

### Modification Example

FIG. 15 is a perspective view illustrating a modification example of the second member 250B of the relay member 250 according to Embodiment 3.

As illustrated in FIG. 15, the second member 250B includes the base portion 251 and the flange portion 252. Further, the base portion 251 has a first reinforcing portion 258a extending in the X-axis direction at the end portion thereof in the +Z direction. Further, the base portion 251 and the flange portion 252 have plate-shaped second reinforcing portions 258b along the YZ plane at both end portions thereof in the X-axis direction. The end portion of the second reinforcing portion 258b on the +Z direction side is the contact portion 256. The first reinforcing portion 258a and the second reinforcing portion 258b are coupled by a triangular plate-shaped third reinforcing portion 258c. By providing the second member 250B with the first reinforcing portion 258a, the second reinforcing portion 258b, and the third reinforcing portion 258c in this way, the rigidity of the second member 250B can be improved, deformation of the second member 250B can be suppressed, and deformation of the communication plate 15 by the second member 250B can be suppressed. The first member 250A can also have the same shape as the second member 250B. Further, in the modification example of Embodiment 3, the first reinforcing portion 258a, the second reinforcing portion 258b, and the third reinforcing portion 258c are provided, but any one or two of these first reinforcing portion 258a, second reinforcing portion 258b, and third reinforcing portion 258c may be provided.

### Other Embodiments

Although each embodiment of the present disclosure was described above, the basic configuration of the present disclosure is not limited to the above description.

For example, in each embodiment described above, the case member 40 and the communication plate 15 were directly joined, but the present disclosure is not particularly limited thereto, and the case member 40 and the communication plate 15 may be joined via a filter that catches dust and air bubbles contained in ink. It is needless to say that the filter may be provided in the middle of the third manifold portion 42. That is, the case member 40 and the filter may be an example of a “case”.

Further, in Embodiments 2 and 3, the same ribs 257 as the modification example of Embodiment 1 may be provided. By providing the relay member 250 of Embodiments 2 and 3 with the rib 257, the rigidity of the relay member 250 can be improved.

Further, in each of the embodiments described above, a thin-film piezoelectric actuator 300 was used as the drive element to generate pressure changes in the pressure chamber 12, but the present disclosure is not particularly limited thereto, and as the drive element, for example, a thick-film piezoelectric actuator formed by methods such as attaching a green sheet, or a longitudinal vibration type piezoelectric actuator that expands and contracts in the axial direction by alternately laminating a piezoelectric material and an electrode forming material, can be used. Further, as the drive element, a configuration in which a heating element is disposed in the pressure chamber 12 to eject liquid droplets from the nozzle 21 by bubbles generated by heat generation of the heating element, or a so-called electrostatic actuator that generates static electricity between a diaphragm and an electrode and deforms the diaphragm by electrostatic force to eject liquid droplets from the nozzle 21, can be used.

Further, in each of the embodiments described above, a thin-film piezoelectric actuator 300 was used as the drive element to generate pressure changes in the pressure chamber 12, but the present disclosure is not particularly limited thereto, and as the drive element, for example, a thick-film piezoelectric actuator formed by methods such as attaching a green sheet, or a longitudinal vibration type piezoelectric actuator that expands and contracts in the axial direction by alternately laminating a piezoelectric material and an electrode forming material, can be used. Further, as the drive element, a configuration in which a heating element is disposed in the pressure chamber 12 to eject liquid droplets from the nozzle 21 by bubbles generated by heat generation of the heating element, or a so-called electrostatic actuator that generates static electricity between a diaphragm and an electrode and deforms the diaphragm by electrostatic force to eject liquid droplets from the nozzle 21, can be used.

### ADDENDUM

From the examples illustrated above, for example, the following configurations can be understood.

According to Aspect 1, which is a preferred aspect, there is provided a liquid ejecting head including a first head chip having a nozzle for ejecting liquid in a first direction, a holder disposed in a second direction opposite to the first direction and holding the first head chip, and a relay member, in which the first head chip includes a first flow path member having a flow path communicating with the nozzle, a pressure chamber substrate having a pressure chamber communicating with the nozzle laminated on the first flow path member in the second direction, a drive element for generating a pressure change in liquid within the pressure chamber, a flexible substrate electrically coupled to the drive element, a protective substrate laminated on the pressure chamber substrate in the second direction and accommodating the drive element, and a second flow path member having a flow path communicating with the flow path of the first flow path member and an opening portion into which the flexible substrate is inserted, the second flow path member being laminated on the first flow path member in the second direction at a position different from a position of the pressure chamber substrate, and the relay member is a member that is inserted into the opening portion of the second flow path member and does not define a flow path through which liquid flows, the relay member including a contact portion that contacts an upper surface of the protective substrate facing the second direction, and a supported portion supported by the holder. Accordingly, when an external force is applied in the second direction from the nozzle surface side of the liquid ejecting head due to a printing medium colliding with the nozzle surface, the movement of the protective substrate in the second direction can be restricted by the holder via the relay member. Therefore, deformation of the first flow path member due to an external force can be suppressed, and the first flow path member can be suppressed from cracking.

In Aspect 2, which is a specific example of the Aspect 1, the contact portion of the relay member is in contact with the upper surface of the protective substrate without being adhered thereto, and the supported portion of the relay member is disposed with a gap from the holder and fixed to the holder by an adhesive disposed in the gap. Accordingly, by not adhering the relay member to the protective substrate, the influence of deformation of the holder or the relay member due to the difference in linear expansion coefficients between the holder or the relay member and the protective substrate can be prevented from being transmitted to the protective substrate, and damage to the piezoelectric actuator 300 can be suppressed.

In Aspect 3, which is a specific example of the Aspect 1, the relay member includes a base portion extending from the contact portion in the second direction beyond the second flow path member, and a flange portion extending from the base portion in a direction orthogonal to the second direction, and the supported portion is provided on the flange portion. Accordingly, by providing the flange portion, the pressure-receiving area can be increased, and deformation of the holder can be suppressed.

In Aspect 4, which is a specific example of Aspect 1, the supported portion is supported by a lower surface of the holder facing the first direction. As a result, by receiving the relay member on the lower surface of the holder, it is easy to suppress the deformation of the first flow path member.

In Aspect 5, which is a specific example of Aspect 4, a recessed portion for accommodating the supported portion is formed on an upper surface of the second flow path member facing the second direction. Accordingly, by providing the second flow path member with the recessed portion and accommodating the supported portion within the recessed portion, the liquid ejecting head can be miniaturized in the second direction.

In Aspect 6, which is a specific example of the Aspect 4, the relay member includes a rib protruding in the second direction beyond the supported portion. Accordingly, by improving the rigidity of the relay member, deformation of the relay member can be suppressed, and deformation of the first flow path member can be further suppressed.

In Aspect 7, which is a specific example of the Aspect 1, the supported portion is supported by an upper surface of the holder facing the second direction. Accordingly, after completing the positioning of the head chip with respect to the holder, the relay member can be inserted from the surface of the holder facing the second direction and fixed to the holder. Therefore, the influence of fixing the relay member to the holder can be suppressed from affecting the positioning of the head chip with respect to the holder. Further, because the gap between the second flow path member and the holder can be reduced, the flow path provided in the second flow path member can be suppressed from becoming narrow.

In Aspect 8, which is a specific example of Aspect 7, a recessed portion for accommodating the supported portion is formed on the upper surface of the holder. Accordingly, by providing the holder with the recessed portion and accommodating the supported portion within the recessed portion, the liquid ejecting head can be miniaturized in the second direction.

In Aspect 9, which is a specific example of the Aspect 1, the relay member has an annular opening portion for inserting the flexible substrate when viewed in the first direction. Accordingly, by improving the rigidity of the relay member, deformation of the relay member can be suppressed, and deformation of the first flow path member can be further suppressed.

In Aspect 10, which is a specific example of the Aspect 1, the flexible substrate has a first surface and a second surface opposite to the first surface, and the relay member includes a first member facing the first surface and a second member separated from the first member and facing the second surface. Accordingly, it is easy to secure a space for inserting the flexible substrate between the first member and the second member, and assemblability can be improved.

In Aspect 11, which is a specific example of the Aspect 10, a drive circuit for driving the drive element is provided on the second surface of the flexible substrate, the first member is formed of metal, and the second member is formed of resin. Accordingly, by forming the second member from resin, conduction between the drive circuit and the second member can be suppressed, and electrical defects due to conduction can be suppressed. Further, by forming the first member from metal, the rigidity of the first member can be improved, and deformation of the first flow path member can be suppressed.

In Aspect 12, which is a specific example of Aspect 1, the liquid ejecting apparatus further includes a second head chip having a nozzle for ejecting liquid, and a fixing plate to which the first head chip and the second head chip are fixed, the fixing plate having a plurality of exposure opening portions for exposing the nozzle of the first head chip and the nozzle of the second head chip to the outside, in which the holder holds the first head chip and the second head chip between the holder and the fixing plate.

According to Aspect 13, which is a preferred aspect, the liquid ejecting apparatus includes the liquid ejecting head described in any one of Aspects 1 to 12, and a liquid storage portion for storing liquid to be supplied to the liquid ejecting head. The liquid ejecting apparatus that suppresses damage of the liquid ejecting head can be realized.

What is claimed is:

1. A liquid ejecting head comprising:
a first head chip having a nozzle configured to eject liquid in a first direction;
a holder disposed in a second direction opposite to the first direction and holding the first head chip; and
a relay member, wherein
the first head chip includes
a first flow path member having a flow path communicating with the nozzle,
a pressure chamber substrate having a pressure chamber communicating with the nozzle and laminated on the first flow path member in the second direction,
a drive element for generating a pressure change in liquid within the pressure chamber,
a flexible substrate electrically coupled to the drive element,
a protective substrate laminated on the pressure chamber substrate in the second direction and accommodating the drive element, and
a second flow path member having a flow path communicating with the flow path of the first flow path member and an opening portion into which the flexible substrate is inserted, the second flow path member being laminated on the first flow path member in the second direction at a position different from a position of the pressure chamber substrate, and
the relay member is a member that is inserted into the opening portion of the second flow path member and does not define a flow path through which liquid flows, the relay member including a contact portion that contacts an upper surface of the protective substrate facing the second direction, and a supported portion supported by the holder.

2. The liquid ejecting head according to claim 1, wherein
the contact portion of the relay member is in contact with the upper surface of the protective substrate without being adhered thereto, and
the supported portion of the relay member is disposed with a gap from the holder and fixed to the holder by an adhesive disposed in the gap.

3. The liquid ejecting head according to claim 1, wherein
the relay member includes a base portion extending from the contact portion in the second direction beyond the second flow path member, and a flange portion extending from the base portion in a direction orthogonal to the second direction, and
the supported portion is provided on the flange portion.

4. The liquid ejecting head according to claim 1, wherein
the supported portion is supported by a lower surface of the holder facing the first direction.

5. The liquid ejecting head according to claim 4, wherein
a recessed portion for accommodating the supported portion is formed on an upper surface of the second flow path member facing the second direction.

6. The liquid ejecting head according to claim 4, wherein
the relay member includes a rib protruding in the second direction beyond the supported portion.

7. The liquid ejecting head according to claim 1, wherein
the supported portion is supported by an upper surface of the holder facing the second direction.

8. The liquid ejecting head according to claim 7, wherein
a recessed portion for accommodating the supported portion is formed on the upper surface of the holder.

9. The liquid ejecting head according to claim 1, wherein
the relay member has an annular opening portion for inserting the flexible substrate when viewed in the first direction.

10. The liquid ejecting head according to claim 1, wherein
the flexible substrate has a first surface and a second surface opposite to the first surface, and
the relay member includes a first member facing the first surface and a second member separated from the first member and facing the second surface.

11. The liquid ejecting head according to claim 10, wherein
a drive circuit for driving the drive element is provided on the second surface of the flexible substrate,
the first member is formed of metal, and
the second member is formed of resin.

12. The liquid ejecting head according to claim 1, further comprising:
a second head chip having a nozzle for ejecting liquid; and
a fixing plate to which the first head chip and the second head chip are fixed, the fixing plate having a plurality of exposure opening portions for exposing the nozzle of the first head chip and the nozzle of the second head chip to the outside, wherein
the holder holds the first head chip and the second head chip between the holder and the fixing plate.

13. A liquid ejecting apparatus comprising:
the liquid ejecting head according to claim 1; and
a liquid storage portion for storing liquid to be supplied to the liquid ejecting head.
